(19) United States
(12) Patent Application Publication
(10) Pub. No.: US 2023/0092640 A1
(43) Pub. Date: Mar. 23, 2023

(54) BODY HEIGHT ESTIMATING APPARATUS, BODY HEIGHT ESTIMATING METHOD, AND NON-TRANSITORY STORAGE MEDIUM

(71) Applicant: NEC Corporation, Minato-ku, Tokyo (JP)

(72) Inventors: Soma SHIRAISHI, Tokyo (JP); Katsumi KIKUCHI, Tokyo (JP); Takami SATO, Tokyo (JP); Yu NABETO, Tokyo (JP)

(73) Assignee: NEC Corporation, Minato-ku, Tokyo (JP)

(21) Appl. No.: 17/802,363

(22) PCT Filed: Mar. 19, 2020
(86) PCT No.: PCT/JP2020/012429

§ 371 Date: Aug. 25, 2022

(51) Int. Cl. G06T 7/60; G06V 10/764; G06V 40/10

(52) U.S. Cl. CPC G06T 7/60; G06V 10/764; G06V 40/103; G06T 2207/30196

(57) ABSTRACT

A body height estimating apparatus (10) includes an acquisition unit (110), an image processing unit (120), and an estimation unit (130). The acquisition unit (110) acquires an image generated by an image capture unit (20). The image processing unit (120) processes the image generated by the image capture unit (20), and thereby generates analysis data. The analysis data include a height of a palm and an angle of an arm of a person included in the image. The estimation unit (130) computes an estimated value of a body height of the person by using the height of the palm and the angle of the arm included in the analysis data.

### TECHNICAL FIELD

The present invention relates to a body height estimating apparatus, a body height estimating method, and a program.

### BACKGROUND ART

In recent years, it has been considered that a trend or an attribute of a customer at a store or the like is associated with a product that the customer holds in his/her hand. For example, Patent Document 1 describes that, in order to determine whether a person reaching his/her hand for a display shelf is a store clerk or a customer, a behavioral pattern of when reaching his/her hand for a display shelf is used. Specifically, Patent Document 1 describes that the person is determined as a store clerk when the behavioral pattern is equivalent to a behavioral pattern of a store clerk.

### RELATED DOCUMENT

### Patent Document

Patent Document 1: International Publication No. WO 2016/194274

### SUMMARY OF THE INVENTION

### Technical Problem

One of attributes of a person is a body height. When an image including a whole body of a person can be acquired, a body height of the person can be estimated by processing the image. However, an image may sometimes include only a palm and an arm of a person, depending on an installation position of an image capturing unit. The present inventor considered estimating a body height of a person by processing an image in which a palm and an arm of the person are captured.

One of objects of the present invention is estimating a body height of a person by processing an image in which a palm and an arm of the person are captured.

### Solution to Problem

According to the present invention, provided is a body height estimating apparatus including:
an image processing unit for processing an image including an arm of a person, and thereby generating analysis data including a height of a palm and an angle of an arm of the person; and
an estimation unit for computing an estimated value of a body height of the person by using the height of the palm and the angle of the arm.

According to the present invention, provided is a body height estimating method including,

by a computer:
processing an image including an arm of a person, and thereby generating analysis data including a height of a palm and an angle of an arm of the person; and
computing an estimated value of a body height of the person by using the height of the palm and the angle of the arm.

According to the present invention, provided is a program causing a computer to include:
an image processing function of processing an image including an arm of a person, and thereby generating analysis data including a height of a palm and an angle of an arm of the person; and
an estimation function of computing an estimated value of a body height of the person by using the height of the palm and the angle of the arm.

### Advantageous Effects of Invention

According to the present invention, a body height of a person can be estimated by processing an image in which a palm and an arm of the person are captured.

### BRIEF DESCRIPTION OF THE DRAWINGS

The above-described object and other objects, features, and advantageous effects become more apparent from the preferred example embodiment described below and the following accompanying drawings.

FIG. 1 is a diagram illustrating a usage environment of a body height estimating apparatus according to an example embodiment.

FIG. 2 is a diagram for describing an image capture apparatus.

FIG. 3 is a diagram illustrating one example of a function configuration of the body height estimating apparatus.

FIG. 4 is a diagram for describing one example of processing performed by an image processing unit.

FIG. 5 is a diagram illustrating one example of a method of estimating a body height of a person by an estimation unit.

FIG. 6 is a diagram illustrating a hardware configuration example of the body height estimating apparatus.

FIG. 7 is a flowchart illustrating one example of processing of the body height estimating apparatus.

### DESCRIPTION OF EMBODIMENTS

Hereinafter, an example embodiment of the present invention will be described by using the drawings. Note that, a similar component is assigned with a similar reference sign throughout all the drawings, and description therefore will be omitted as appropriate.

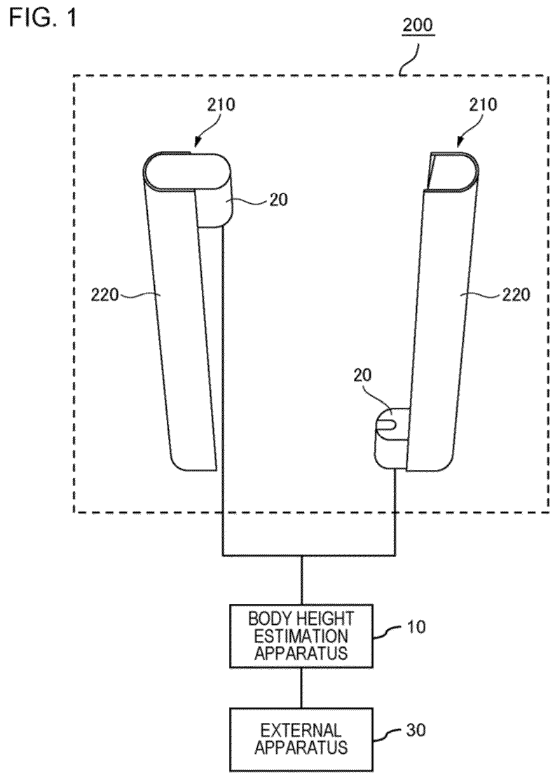

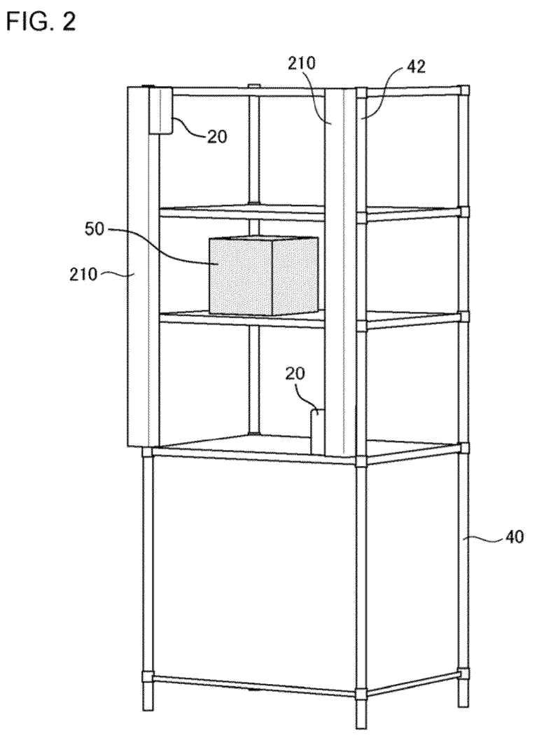

FIG. 1 is a diagram illustrating a usage environment of a body height estimating apparatus 10 according to an example embodiment. FIG. 2 is a diagram for describing an image capture apparatus 200. The body height estimating apparatus 10 estimates a body height of a person by processing an image generated by the image capture apparatus 200. More specifically, the body height estimating apparatus 10 estimates a body height of a person reaching his/her hand for an article shelf 40.

The article shelf 40 is arranged in, for example, a store or a warehouse, and includes at least one shelf. An article 50, for example, a product, is placed on the shelf. In other words, the shelf of the article shelf 40 is one example of a product placement area.

The image capture apparatus 200 photographs the shelf of the article shelf 40 and front thereof. Then, the image capture apparatus 200 includes two image capturing units 210. Each of the two image capturing units 210 includes a lighting unit 220 and an image capture unit 20. One image capture unit 20 is one example of a first image capture unit, and another image capture unit 20 is one example of a second image capture unit.

The lighting unit 220 has a light irradiation surface extending in one direction, and includes a light-emitting unit and a cover covering the light-emitting unit. The lighting unit 220 mainly irradiates light in a direction orthogonal to an extending direction of the light irradiation surface. The light-emitting unit includes a light-emitting element such as an LED, and irradiates light in a direction not covered by the cover. Note that, when the light-emitting element is an LED, a plurality of LEDs are arranged in a direction (a vertical direction in the figure) in which the lighting unit 220 extends.

Then, the image capture unit 20 is provided on one end side of the lighting unit 220, and has an imaging range in a direction in which light of the lighting unit 220 is irradiated. For example, in the left-hand side image capturing unit 210 in FIGS. 1 and 2, the image capture unit 20 has an imaging range downward and obliquely lower right. Further, in the right-hand side image capturing unit 210 in FIGS. 1 and 2, the image capture unit 20 has an imaging range upward and obliquely upper left.

As illustrated in FIG. 2, the two image capturing units 210 are attached to front frames (or front faces of side walls on both sides) 42 of the article shelf 40. At this time, the first image capturing unit 210 is attached to one front frame 42 in a direction with the image capture unit 20 positioned upward, and the second image capturing unit 210 is attached to the front frame 42 on an opposite side of the first image capturing unit 210 in a direction with the image capture unit 20 positioned downward. Thus, the one image capture unit 20, the article shelf 40, and the another image capture unit 20 are arranged in this order in a direction (one example of a first direction) in which the shelf extends. Further, the one image capture unit 20 is positioned higher than the shelf of the article shelf 40, and the another image capture unit 20 is positioned lower than the shelf of the article shelf 40.

Then, the image capture unit 20 of the first image capturing unit 210 images downward and obliquely downward of the image capture unit 20 in such a way that an opening of the article shelf 40 and front thereof are included in the imaging range. On the other hand, the image capture unit 20 of the second image capturing unit 210 images upward and obliquely upward in such a way that an opening of the article shelf 40 and front thereof are included in the imaging range. By using the two image capturing units 210 in this way, an entire range of an opening of the article shelf 40 and front thereof can be photographed. Thus, when an image generated by the image capture apparatus 200 is processed, an article taken out from the article shelf 40 can be determined. The processing may be performed by the body height estimating apparatus 10.

Further, when a person positioned in front of the article shelf 40 reaches his/her hand for the article 50, an image generated by the first image capturing unit 210 includes a palm and an arm of the person. The body height estimating apparatus 10 estimates a height of the palm and an angle of the arm by processing the image generated by the image capturing unit 210. Then, the body height estimating apparatus 10 estimates a body height of the person by using the height of the palm and the angle of the arm. A processing result of the body height estimating apparatus 10 is output to an external apparatus 30. When the article shelf 40 is arranged at a store, the external apparatus 30 is an apparatus collecting a trend of a customer on the article 50.

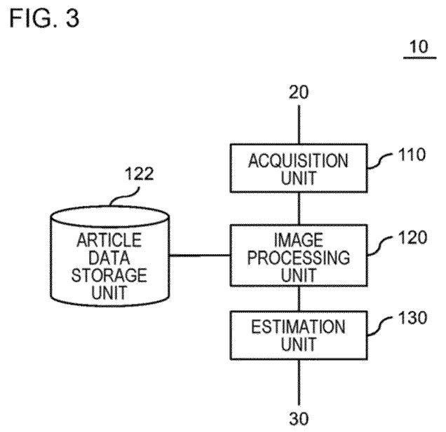

FIG. 3 is a diagram illustrating one example of a function configuration of the body height estimating apparatus 10. In an example illustrated in the present figure, the body height estimating apparatus 10 includes an acquisition unit 110, an image processing unit 120, and an estimation unit 130. The acquisition unit 110 acquires an image generated by the image capture unit 20. In an example illustrated in FIGS. 1 and 2, the acquisition unit 110 acquires an image from each of the two image capture units 20. The image processing unit 120 generates analysis data by processing an image generated by the image capture unit 20. The analysis data include a height of a palm and an angle of an arm of a person included in the image. The estimation unit 130 computes an estimated value of a body height of a person by using a height of a palm and an angle of an arm included in analysis data.

Further, the image processing unit 120 may use data stored in an article data storage unit 122 when generating analysis data. The article data storage unit 122 stores, for each article (for example, for each product), a feature value and magnitude of the article.

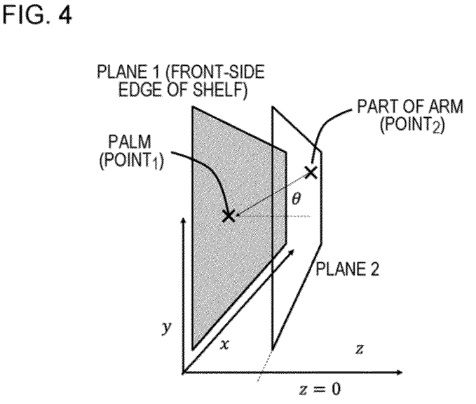

FIG. 4 is a diagram for describing one example of processing performed by the image processing unit 120. As described above, analysis data generated by the image processing unit 120 include a height of a palm and an angle of an arm. Then, in an example illustrated in FIG. 4, an x-axis indicates a depth direction, for example, a direction in which the article shelf 40 extends, and a y-z plane is related to an image photographed by the image capture unit 20.

First, the image processing unit 120 determines a position (a point ₁ in FIG. 4) of a palm in an image, and computes a height of the palm by using the position and an installation position of the image capture unit 20. For the computation, for example, a transformation formula based on an installation position of the image capture unit 20 is used.

There are a plurality of methods of detecting a position of a palm. For example, when a hand of a person is going to take out the article 50 from the article shelf 40, the image processing unit 120 detects the article 50 by using a feature value stored in the article data storage unit 122, and estimates a position of the article 50 as a position of a palm. At this time, the image processing unit 120 may detect a moving article 50, and estimate a position of the article 50 as the point ₁ being a position of a palm.

Further, the image processing unit 120 may first detect an arm, and determine, as a palm, a part of the arm overlapping a front-side edge (that is, a plane 1 in FIG. 4) of the article shelf 40 in a depth direction (a z-axis direction in FIG. 4) of the article shelf 40. Further, when the moving article 50 passes through the plane 1, the image processing unit 120 may detect a position of the article 50 at that time as a position (the point ₁) of a palm.

Then, the image processing unit 120 determines any part (a point ₂ in FIG. 4) of an arm in the image. The determination may be performed by, for example, detecting a feature value of the arm, or may be performed by using skeleton estimation processing.

Then, the image processing unit 120 assumes that the point ₁ and the point ₂ are at an identical position, that is, have an identical x-coordinate to each other in a depth direction (for example, a direction in which the article shelf 40 extends) in FIG. 4. Then, an angle of a line connecting between the point ₁ and the point ₂ in the y-z plane is estimated to be an angle θ of the arm.

Note that, an area of a region occupied by the article 50 in an image becomes smaller as the article 50 goes farther from the image capture unit 20 (that is, as an x-axis coordinate becomes larger). In view of this, the image processing unit 120 may compute the angle θ of an arm by using an area of a region occupied by the article 50 in an image. Specifically, the image processing unit 120 determines a type of the article 50, and reads out magnitude related to the type from the article data storage unit 122. Then, by using the magnitude and an area of a region occupied by the article 50 in an image, an x-coordinate of the point ₁ in FIG. 4 is computed. The image processing unit 120 computes the angle θ of an arm by using the x-coordinate.

Further, when a height of each article 50 on the article shelf 40 is stored in advance in the article data storage unit 122 or the like for each type of the article 50, the image processing unit 120 may determine a type of the moving article 50 and estimate a height of the article 50 related to the type as a height of a palm.

Further, when a height of each shelf of the article shelf 40 is stored in advance, the image processing unit 120 may determine a shelf for which a hand is reached and determine a height of a palm by reading out a height of the shelf.

Further, when the image capture unit 20 includes a function of generating depth information, the image processing unit 120 may determine, by using the depth information, positions of two points of an arm on three-dimensional, that is, on real space and compute an angle of the arm by connecting the two points.

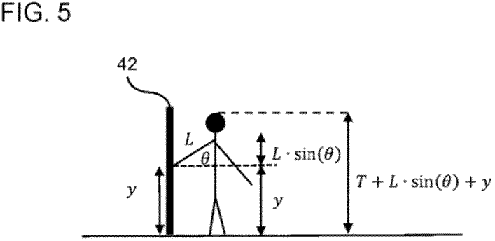

FIG. 5 is a diagram illustrating one example of a method of estimating a body height of a person by the estimation unit 130. In the present figure, when a height of a palm is denoted by y, a length of an arm of a person is denoted by L, and a height from a shoulder joint (shoulder) to a top of a head is denoted by T, a body height H of a person is represented by a formula (1) below.

$$\text{H=T+L} \times sin \left(θ\right) \text{+y} ⋯$$

Thus, when a standard value of T and a standard value of L are stored in advance, the estimation unit 130 can estimate a body height of a person in accordance with the formula (1).

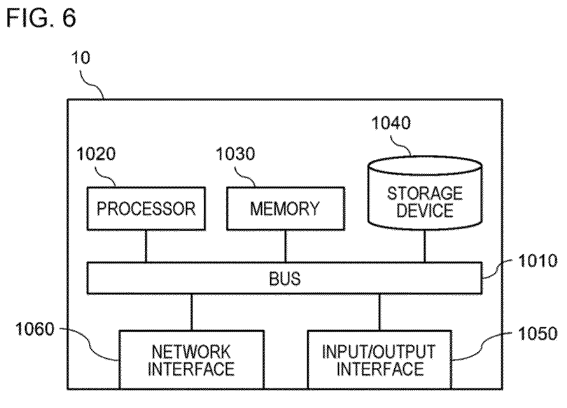

FIG. 6 is a diagram illustrating a hardware configuration example of the body height estimating apparatus 10. The body height estimating apparatus 10 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit and receive data to and from one another. However, a method of connecting the processor 1020 and the like with one another is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module for achieving each function (for example, the acquisition unit 110, the image processing unit 120, and the estimation unit 130) of the body height estimating apparatus 10. Each of the program modules is read into the memory 1030 and executed by the processor 1020, and thereby each function relevant to the program module is achieved.

The input/output interface 1050 is an interface for connecting the body height estimating apparatus 10 to various types of input/output devices.

The network interface 1060 is an interface for connecting the body height estimating apparatus 10 to a network. The network is, for example, a local area network (LAN) or a wide area network (WAN). A method by which the network interface 1060 connects to the network may be wireless connection, or may be wired connection. The body height estimating apparatus 10 may communicate with the image capture unit 20 and the external apparatus 30 via the network interface 1060.

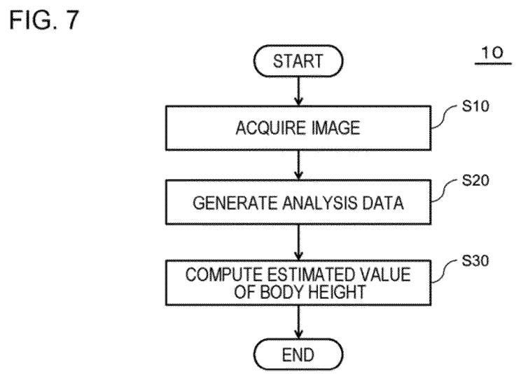

FIG. 7 is a flowchart illustrating one example of processing of the body height estimating apparatus 10. In an example illustrated in the present figure, the image capture unit 20 generates an image at least every time a customer reaches his/her hand for the article shelf 40. Then, every time the image capture unit 20 generates an image including a hand and an arm of a customer, the acquisition unit 110 of the body height estimating apparatus 10 acquires the image (step S10). Next, the image processing unit 120 of the body height estimating apparatus 10 processes the image acquired in step S10, and thereby generates analysis data (step S20). Next, the estimation unit 130 computes an estimated value of a body height of the customer by using the analysis data generated in step S20 (step S30).

According to the present example embodiment described above, with use of the body height estimating apparatus 10, a body height of a person can be estimated by processing an image in which a whole body of the person is not captured but a hand and an arm of the person are included.

While the example embodiment of the present invention has been described with reference to the drawings, the example embodiment is illustrative of the present invention, and various configurations other than the above can be employed.

Further, while a plurality of processes (pieces of processing) are described in order in a plurality of flowcharts used in the above description, execution order of processes executed in each example embodiment is not limited to the described order. The order of the illustrated processes can be changed in each example embodiment, as long as the change does not detract from contents. Further, the above example embodiments can be combined, as long as contents do not contradict each other.

The whole or part of the above-described example embodiment can be described as, but not limited to, the following supplementary notes.
1. A body height estimating apparatus including:
   an image processing unit for processing an image including an arm of a person, and thereby generating analysis data including a height of a palm and an angle of an arm of the person; and
   an estimation unit for computing an estimated value of a body height of the person by using the height of the palm and the angle of the arm.
2. The body height estimating apparatus according to supplementary note 1, wherein
   the image includes a product placement area and front thereof, and
   the image processing unit determines a part of the arm overlapping a front-side edge of the product placement area as the palm.
3. The body height estimating apparatus according to supplementary note 1, wherein
   the image includes a product placement area and front thereof, and
   the image processing unit detects a product moved from the product placement area, and determines a height of the product as the height of the hand.
4. The body height estimating apparatus according to supplementary note 1, wherein
   the image includes a product placement area and front thereof,
   for each type of a product, a height of the product is stored in advance, and
   the image processing unit detects a type of a product moved from the product placement area, and determines a height of the product related to the type as the height of the hand.
5. The body height estimating apparatus according to any one of supplementary notes 2 to 4, wherein
   the product placement area is at least a part of a product shelf, and
   the image is generated by an image capture unit attached to a front frame of the product shelf.
6. A body height estimating method including,
   by a computer:
   processing an image including an arm of a person, and thereby generating analysis data including a height of a palm and an angle of an arm of the person; and
   computing an estimated value of a body height of the person by using the height of the palm and the angle of the arm.
7. The body height estimating method according to supplementary note 6, wherein
   the image includes a product placement area and front thereof,
   the body height estimating method further including,
   by the computer, determining a part of the arm overlapping a front-side edge of the product placement area as the palm.
8. The body height estimating method according to supplementary note 6, wherein
   the image includes a product placement area and front thereof,
   the body height estimating method further including,
   by the computer, detecting a product moved from the product placement area, and determining a height of the product as the height of the hand.
9. The body height estimating method according to supplementary note 6, wherein
   the image includes a product placement area and front thereof, and
   for each type of a product, a height of the product is stored in advance,
   the body height estimating method further including, by the computer, detecting a type of a product moved from the product placement area, and determining a height of the product related to the type as the height of the hand.
10. The body height estimating method according to any one of supplementary notes 7 to 9, wherein
   the product placement area is at least a part of a product shelf, and
   the image is generated by an image capture unit attached to a front frame of the product shelf.
11. A program causing a computer to include:
   an image processing function of processing an image including an arm of a person, and thereby generating analysis data including a height of a palm and an angle of an arm of the person; and
   an estimation function of computing an estimated value of a body height of the person by using the height of the palm and the angle of the arm.
12. The program according to supplementary note 11, wherein
   the image includes a product placement area and front thereof, and
   the image processing function determines a part of the arm overlapping a front-side edge of the product placement area as the palm.
13. The program according to supplementary note 11, wherein
   the image includes a product placement area and front thereof, and
   the image processing function detects a product moved from the product placement area, and determines a height of the product as the height of the hand.
14. The program according to supplementary note 11, wherein
   the image includes a product placement area and front thereof,
   for each type of a product, a height of the product is stored in advance, and
   the image processing function detects a type of a product moved from the product placement area, and determines a height of the product related to the type as the height of the hand.
15. The program according to any one of supplementary notes 12 to 14, wherein
   the product placement area is at least a part of a product shelf, and
   the image is generated by an image capture unit attached to a front frame of the product shelf.

### REFERENCE SIGNS LIST

10 Body height estimating apparatus
20 Image capture unit
30 External apparatus
40 Article shelf
42 Front frame
50 Article
110 Acquisition unit
120 Image processing unit
130 Estimation unit
200 Image capture apparatus
210 Image capturing unit
220 Lighting unit

What is claimed is:

1. A body height estimating apparatus comprising:
at least one memory configured to store instructions: and
at least one processor configured to execute the instructions to perform operations comprising:
processing an image including an arm of a person, and thereby generating analysis data including a height of a palm and an angle of an arm of the person; and
computing an estimated value of a body height of the person by using the height of the palm and the angle of the arm.

2. The body height estimating apparatus according to claim 1, wherein
the image includes a product placement area and front thereof, and
processing an image comprises determining a part of the arm overlapping a front-side edge of the product placement area as the palm.

3. The body height estimating apparatus according to claim 1, wherein
the image includes a product placement area and front thereof, and
processing an image comprises detecting a product moved from the product placement area, and determining a height of the product as the height of the palm.

4. The body height estimating apparatus according to claim 1, wherein
the image includes a product placement area and front thereof,
for each type of a product, a height of the product is stored in advance, and
processing an image comprises detecting a type of a product moved from the product placement area, and determining a height of the product related to the type as the height of the palm.

5. The body height estimating apparatus according claim 2, wherein
the product placement area is at least a part of a product shelf, and
the image is generated by an image capture unit attached to a front frame of the product shelf.

6. A body height estimating method executed by a computer, the body height estimating method comprising:
processing an image including an arm of a person, and thereby generating analysis data including a height of a palm and an angle of an arm of the person; and
computing an estimated value of a body height of the person by using the height of the palm and the angle of the arm.

7. A non-transitory storage medium storing a program causing a computer to execute a body height estimating method, the body height estimating method comprising:
processing an image including an arm of a person, and thereby generating analysis data including a height of a palm and an angle of an arm of the person; and
computing an estimated value of a body height of the person by using the height of the palm and the angle of the arm.

8. The body height estimating method according to claim 6, wherein
the image includes a product placement area and front thereof, and
processing an image comprises determining a part of the arm overlapping a front-side edge of the product placement area as the palm.

9. The body height estimating method according to claim 6, wherein
the image includes a product placement area and front thereof, and
processing an image comprises detecting a product moved from the product placement area, and determining a height of the product as the height of the palm.

10. The body height estimating method according to claim 6, wherein
the image includes a product placement area and front thereof,
for each type of a product, a height of the product is stored in advance, and
processing an image comprises detecting a type of a product moved from the product placement area, and determining a height of the product related to the type as the height of the palm.

11. The body height estimating method according to claim 8, wherein
the product placement area is at least a part of a product shelf, and
the image is generated by an image capture unit attached to a front frame of the product shelf.

12. The non-transitory storage medium according to claim 7, wherein
the image includes a product placement area and front thereof, and
processing an image comprises determining a part of the arm overlapping a front-side edge of the product placement area as the palm.

13. The non-transitory storage medium according to claim 7, wherein
the image includes a product placement area and front thereof, and
processing an image comprises detecting a product moved from the product placement area, and determining a height of the product as the height of the palm.

14. The non-transitory storage medium according to claim 7, wherein
the image includes a product placement area and front thereof,
for each type of a product, a height of the product is stored in advance, and
processing an image comprises detecting a type of a product moved from the product placement area, and determining a height of the product related to the type as the height of the palm.

15. The non-transitory storage medium according to claim 12, wherein
the product placement area is at least a part of a product shelf, and
the image is generated by an image capture unit attached to a front frame of the product shelf.
